(19) United States
(12) Patent Application Publication
(10) Pub. No.: US 2019/0162211 A1
(43) Pub. Date: May 30, 2019

(54) A method and a system for controlling the driving engine and hydraulic pumps of a hydraulic machine, as well as a pile driving rig

(71) Applicant: Junttan Oy, Kuopio (FI)

(72) Inventors: Ville Lyytikäinen, Kuopio (FI); Jaakko Paavola, Juankoski (FI)

(73) Assignee: Junttan Oy, Kuopio (FI)

(21) Appl. No.: 16/091,581

(22) PCT Filed: Apr. 8, 2016
(86) PCT No.: PCT/FI2016/050225

§ 371 Date: Oct. 5, 2018

(51) Int. Cl. F15B 21/08; E02D 7/14; E02D 7/22; E02D 7/18; F15B 11/00

(52) U.S. Cl. CPC F15B 21/08; E02D 7/14; E02D 7/16; E02D 7/18; F15B 11/00; E02D 7/22

(57) ABSTRACT

The invention relates to a method for controlling the driving engine (M) and hydraulic pumps (PUMP1, PUMP2) of a hydraulic machine (10), the method comprising: —driving at least one hydraulic variable displacement pump (PUMP1, PUMP2) that supplies pressurized medium to the hydraulic system of the machine by the driving engine (M), —determining the working pressure pi, p2) and volume flow (Qip, Q2p) output from at least one hydraulic pump (PUMP1, PUMP2), —determining the torque (T-ip, T2p) required of at least one hydraulic pump (PUMP1, PUMP2) or the total torque (Tpk0k) required by two or more hydrau¬lic pumps (PUMP1, PUMP2) by means of the working pressure (p-i, p2) and volume flow (Qip, Q2p) of pressurized medium output from at least one hydraulic pump (PUMP1, PUMP2), as well as the rotation speed (i) of the driving engine (M); —controlling the rotation speed (i) of the driving engine (M) and the dis¬placement (V1p, V2p) of at least one hydraulic pump (PUMP1, PUMP2) auto¬matically so that the torque (Td, Tdeff) produced by the driving engine approaches the torque (Tip, T2p) required by at least one hydraulic pump (PUMP1, PUMP2) driven by the driving engine (M), or the total torque (Tpk0k) of two or more hydraulic pumps (PUMP1, PUMP2) in such a way that the volume flow (Q1p, Q2p) produced by at least one hydraulic pump (PUMP1, PUMP2) will remain unchanged. The invention also relates to a system for controlling the driving engine (M) and hydraulic pumps (PUMP1, PUMP2) of a hydraulic machine (10), as well as a pile driving rig comprising the system according to the invention.

### FIELD OF THE INVENTION

The invention relates to a method and a system for controlling the driving engine and hydraulic pumps in a hydraulic machine, as well as a pile driving rig.

### BACKGROUND OF THE INVENTION

A hydraulic machine, such as an earth moving machine, a forest machine or an excavator, comprises several hydraulic actuators for controlling and moving the apparatuses of the machine (for example the crane and the bucket of an excavator) in a suitable way. For example in a hydraulic pile driving rig, hydraulic actuators are used for controlling the leader, for moving the hammer along the leader by hydraulic winches, and for generating the impacts of the ram. The pressurized medium (typically hydraulic oil) for these actuators is provided with a desired volume flow and pressure by means of one or more hydraulic pumps in the machine. In machines, hydraulic pumps are driven by the driving engine which is still—almost without exception—a combustion engine and typically a diesel engine.

At present, a driving engine that supplies power to hydraulic pumps for pumping pressurized medium to hydraulic actuators, is controlled to provide hydraulic power sufficient for producing the power/torque and velocity/rotation speed required by the hydraulic actuators in all situations required by the operation to be performed by said machine. This has to be done because in a situation in which the power demand of the hydraulic actuators becomes greater than the power generated by the driving engine at the time, the combustion engine used as the driving engine for the machine will stop. To prevent such a situation by using present control methods, the power of the driving engine is normally adjusted in such a way that one or more hydraulic pumps in the machine is capable of generating at least the hydraulic power corresponding to the highest mechanical power required of the actuator for performing said operation or said functions. If the power demand exceeds the maximum power of the driving engine and the hydraulic pumps in use are variable with respect to the displacement, and/or if the hydraulic actuators performing the function are hydraulic engines with variable displacement, it is possible to prevent the driving engine from stalling by controlling the displacement of the hydraulic pumps and/or engines. On the other hand, when the demand of mechanical power and the corresponding hydraulic power is lower than the above-mentioned maximum power demand, pressurized medium pumped in excess is guided by control valves past the actuators directly to the return lines of the hydraulic system and thereby back to the main tank.

A drawback of the present method is that the output capacity of the driving engine (that is, the desired rotation speed and torque) always have to be adjusted according to the maximum output required for performing the operation at hand or the functions of the machine, although carrying out the functions of the operation includes many steps in which this maximum hydraulic output (that is, volume flow and pressure of pressurized medium) is not needed all the time. As a result, much of the hydraulic energy produced by the system and thereby of the energy used by the driving engine is consumed in redundant circulating of pressurized medium from the main tank of the system to the valves and via the return lines back to the main tank of the system. In many situations, it also follows that the driving engine of the hydraulic machine has to be operated at power which is higher than that needed most of the time; as a result, the energy consumption and the emissions of the driving engine become unnecessarily high when the present control method is used. Furthermore, because variable displacement hydraulic pumps are often used in present machines, the same hydraulic power can be generated by applying a number of different rotation speeds of the driving engine. Consequently, the same specific minimum output can be generated by applying different rotation speeds of the driving engine, although only one normally gives the best possible performance of the driving engine and thereby the best energy performance and the lowest possible emissions. Therefore, methods of prior art for controlling the driving engine and the hydraulic pumps often result in inadequate uses of the machine with respect to fuel economy and emissions.

### BRIEF SUMMARY OF THE INVENTION

It is the aim of the invention to provide a method for reducing the energy consumption and improving the energy efficiency of the driving engine of a hydraulic machine, as well as for making the driving engine of the hydraulic machine always operate at an optimal rotation speed, for achieving a minimum energy consumption. It is also an aim of the invention to introduce a system according to the method of the invention, for controlling the driving engine and hydraulic pumps of a hydraulic machine.

The aim of the invention is achieved by a method in which the rotation speed of the driving engine as well as the displacement of one or more hydraulic pumps driven by the driving engine are automatically controlled according to a predetermined value for the volume flow of the pressurized medium, set by the driver of the machine, so that the torque of the driving engine, corresponding to said volume flow, corresponds to the torque required by the hydraulic pump, whereby the driving engine will produce the desired volume flow of pressurized medium with the lowest possible energy consumption. As the power demand and thereby the pressure effective in the system increase, the volume flow produced by the hydraulic pump is automatically turned down by reducing the displacement of the hydraulic pump and, on the other hand, by increasing the rotation speed of the driving engine (when this is possible), whereby the adjusted output of the driving engine of the machine is always sufficient for performing the desired functions. To put it more precisely, the method according to the invention is characterized in what will be presented in the independent claim 1, the system according to the invention in what will be presented in the independent claim 11, and the pile driving rig according to the invention in what will be presented in the independent claim 14. The dependent claims 2 to 10 will present some advantageous embodiments of the method according to the invention, and the dependent claims 12 and 13 will present some advantageous embodiments of the system according to the invention, and the dependent claim 15 will present an advantageous embodiment of the pile driving rig according to the invention.

The method, the system according to the invention have the advantage that it can be applied to make the machine and the hydraulic system of the machine operate in such a way that the energy consumption of the driving engine is reduced and the emissions (particularly carbon dioxide emissions) resulting from the use of the machine are reduced. For example a pile driving rig used for driving rammed piles or bored piles into the ground has a high power demand. Therefore, by reducing the fuel consumption it is possible to significantly reduce the carbon dioxide emissions formed, as well as naturally also influence the costs of the pile driving by reducing the fuel costs.

### DESCRIPTION OF THE DRAWINGS

In the following, the invention will be described in more detail with reference to the appended drawings, in which

FIG. 1 shows a machine equipped with a control system of a driving engine and hydraulic pumps according to the invention, in a side view,

FIG. 2 shows general principle diagram of the hydraulic system of a machine according to FIG. 1,

FIG. 3 shows a diagram which illustrates the correlation between the torque of the driving engine of the machine of FIG. 1 and the rotation speed;

FIG. 4 shows a diagram illustrating the value of a deficiency divisor h determined in the control unit of the machine of FIG. 1 as a function of the pressure p1 of a hydraulic pump PUMP1 when the working pressure of a hydraulic pump PUMP2 has a constant value of 290 bar;

FIG. 5 shows a diagram illustrating the torque values T₁ₚ and T₂ₚ required by the hydraulic pumps PUMP1 and PUMP2 of the machine of FIG. 1, as well as the real torque values T₁ₜ and T₂ₜ as a function of the working pressure of the hydraulic pump PUMP1 when the working pressure of the hydraulic pump PUMP2 has a constant value of 290 bar;

FIG. 6 shows a diagram illustrating the displacements V₁ₚ ja V₂ₚ required of the hydraulic pumps PUMP1 and PUMP2 of the machine of FIG. 1, as well as the real displacements Vᵢₜ and Vₑₜ as a function of the working pressure of the hydraulic pump PUMP1 when the working pressure of the hydraulic pump PUMP2 has a constant value of 290 bar; and

FIG. 7 shows a diagram illustrating the volume flows Q₁ₚ, Q₂ₚ required of the hydraulic pumps PUMP1 and PUMP2 of the machine of FIG. 1 and the required total volume flow _{Qpk0}k as well as the real volume flows Q₁ₚₜ, Q₂ₚₜ and the real total volume flow Qₚₖₒₖ when the working pressure of the hydraulic pump PUMP2 has a constant value of 290 bar.

### DETAILED DESCRIPTION OF SOME ADVANTAGEOUS EMBODIMENTS OF THE INVENTION

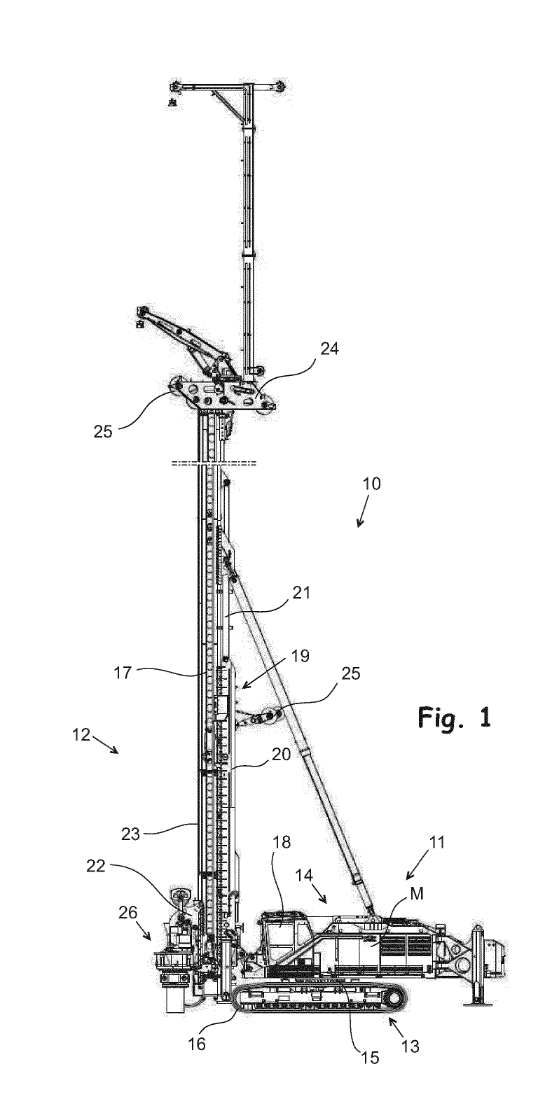

FIG. 1 shows a machine 10 which is a so-called combined pile driving rig for driving bored piles, rammed piles or grooved/steel piles into the ground by vibration or pressing. When the pile driving rig 10 is used for driving bored piles, a bore motor as shown in FIG. 1 is mounted on a slide 22 in a working device 26 on a leader 17. When rammed piles are driven into the ground, the hammer of the pile driving apparatus is mounted on the slide 22, and when grooved/steel piles are driven into the ground by vibration, a vibrator is mounted on the slide 22.

The machine 10 of FIG. 1 comprises a base machine 11 and a pile driving apparatus 12 mounted on it. The base machine 11 consists of an undercarriage 13 moving on the ground by a crawler track 16, by which the machine 10 is moved along the ground surface to a desired location where a pile is to be driven. The undercarriage 13 comprises the crawler track 16 and the required apparatus for moving the machine by them. Above the undercarriage 13, an upper carriage 14 is mounted on the undercarriage 13 to be swivelled in the horizontal direction by means of a swivel 15. A driving engine M is placed in the rear section of the upper carriage 14, and a cabin 18 as well as the required mounting structures and devices for mounting and moving the different parts of the pile driving apparatus 12 are placed in the front section. The different functions of the base machine 11 and the pile driving rig 12 as well as e.g. the transmission for moving the crawler track 16 and changing the travel direction of the base machine 11 are configured to be hydraulically operated by a hydraulics system in the base machine 11. For achieving the different functions, the driving engine M drives hydraulic pumps PUMP1 and PUMP2 belonging to the hydraulics system and generating a flow and a working pressure of pressurized medium in the hydraulic system, for driving actuators for effecting different functions. The cabin 18 is equipped with controls to be applied by the driver of the pile driving rig 10 to control the different functions of the rig. Furthermore, the cabin 18 is equipped with, inter alia, an electronic control unit for controlling the control valves (magnet and/or servo valves) of the hydraulic system for adjusting and controlling the supply of pressurized medium to the different actuators of the hydraulic system.

The pile driving apparatus 12 comprises a leader 17 and an apparatus 26 which may be, for example, a pile driving auger, the hammer of a pile driving rig, or a vibrator. In FIG. 1, the apparatus 26 connected to the leader 17 is a pile driving auger. For connecting the apparatus 26 to the leader 17 in a disengagable manner, a slide 22 is movably connected to the leader in its longitudinal direction and equipped with the necessary mounting means for mounting the apparatus 26 on the slide 22, as well as with the necessary connecting means and hydraulic hoses for connecting the apparatus 26 to the hydraulic system of the base machine 11. The slide is mounted on guide tracks 23 on the leader 17. The slide 22 is moved along the guide tracks 23 via pulling ropes by means of a pull-down winch and a wind-up winch in the base machine 11. Idlers 25 are provided at different locations on the side of the leader 17 and at the cathead 24 at the top of the leader 17, for guiding the pulling ropes from the pull-down and wind-up winches to the slide 22. According to the apparatus, the pulling ropes are guided via different idlers 25 so that in the case of apparatuses 26 of different types, the slide 22 is given the desired velocity and force according to the requirements of the pile driving work or other suitable work to be carried out by said apparatus.

In the machine 10 of FIG. 1, the different functions are hydraulic, such as power transmission to the caterpillar track, turning of the leader to different positions, extending the leader, lowering down of the stabilizers and lifting them up again, moving the apparatuses along the leader, and operating them. For this, the working pressure and the volume flow of the pressurized medium required for the different uses are generated by two hydraulic pumps PUMP1 and PUMP2 in the hydraulic system The hydraulic pumps PUMP1 and PUMP2 are powered by the driving engine M of the machine, which is a diesel engine in this embodiment. The hydraulic pumps PUMP1 and PUMP2 are variable with respect to their displacement, and their displacements V₁ₚ and V₂ₚ are controlled by an electronic controller. For automatic control of the hydraulic system, the machine 10 of FIG. 1 also comprises an electronic control unit for controlling not only the hydraulic system but also e.g. the operation of the driving engine M (e.g. the running speed, i.e. the rotation speed) automatically on the basis of control and measurement signals from other devices of the machine 10.

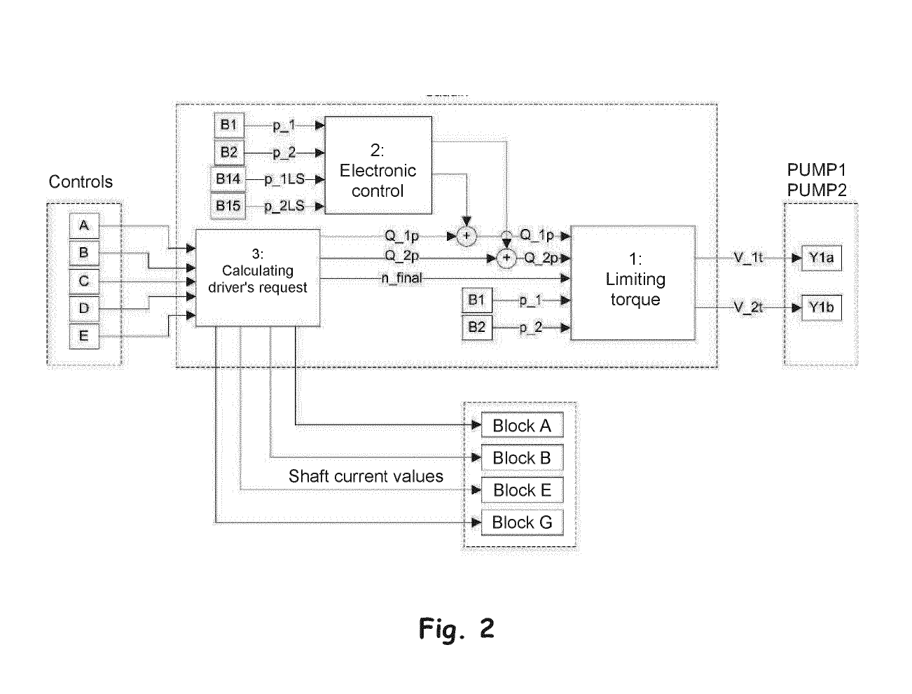

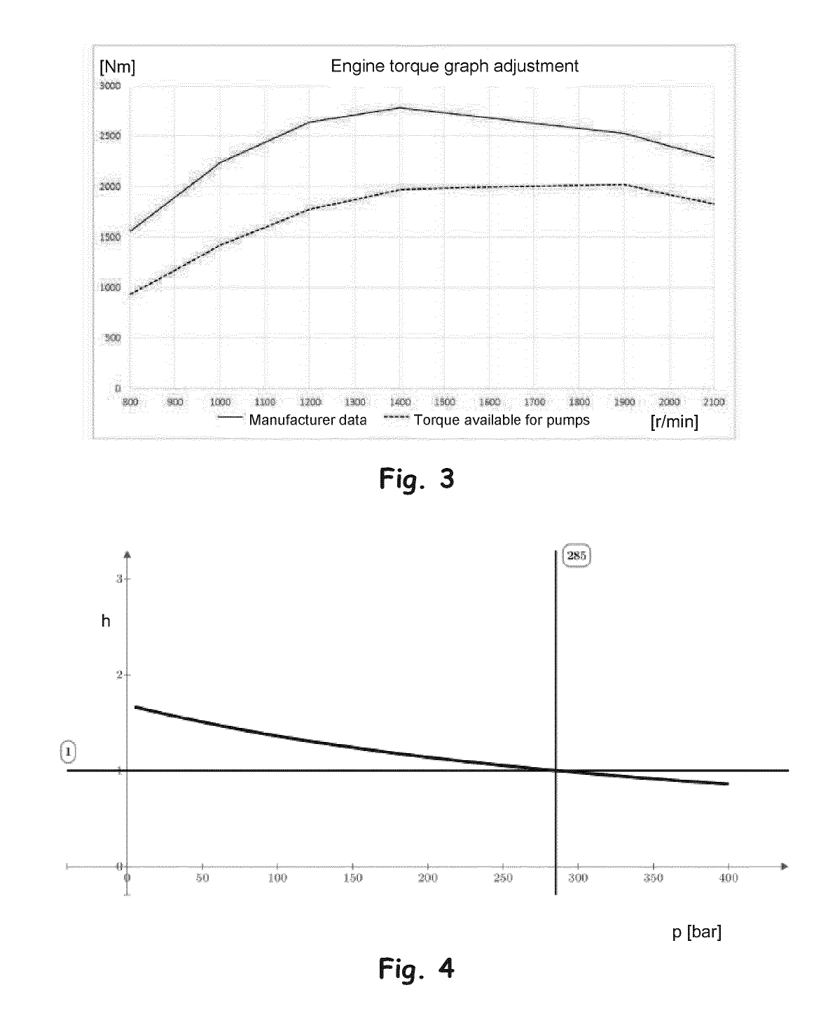

FIG. 2 shows a general principle diagram of the electronic control unit controlling the driving engine M and the hydraulic pumps PUMP1 and PUMP2 of the machine 10 according to FIG. 1. In this embodiment of the system, an electronic controller is used for controlling the displacement of the hydraulic pumps PUMP1 and PUMP2 in such a way that the total torque Tₚₖₒₖ=Tₚ₁+Tₚ₂ required by the hydraulic pumps PUMP1 and PUMP2, determined by the working pressures p₁ ja p₂ of the hydraulic pumps PUMP1 and PUMP2 effective in the system does not exceed the torque T_{d} produced by the driving engine M and corresponding to the rotation speed i; that is, Tₚₖₒₖ≤T_{d}. To prevent this, the control of the hydraulic system is implemented in such a way that it changes the displacements V₁ₚ and V₂ₚ of the hydraulic pumps PUMP1 and PUMP2 as well as increases the rotation speed of the driving engine M (insofar as this is possible) if their working pressures p₁ and p₂ are so high that the output of said volume flows Q₁ₚ and Q₂ₚ at the initial rotation speed i would require a torque of the driving engine M higher than the torque the driving engine M is capable of producing at this rotation speed i. In this embodiment, the torque T_{d} output by the driving engine M and corresponding to a given rotation speed i of the driving engine is obtained from the chart of rotation speed/torque provided by the engine manufacturer. FIG. 3 shows the chart of rotation speed/torque for the driving engine M of the machine according to FIG. 1.

For estimating if the torque Td output by the driving engine M will be exceeded, a special reference parameter to be defined for this purpose, i.e. so-called deficiency divisor h, is used in the method according to this invention. In general, in such a hydraulic system that comprises a driving engine for powering one or more hydraulic pumps, the relation between the torque output by the driving engine and the torques required by the hydraulic pumps can be assessed by defining a deficiency divisor h(i) dependent on the rotation speed of the driving engine as follows:

$$h ( i ) = \frac{{T}_{d} ( i )}{{T}_{pkok} ( i )} = \frac{{T}_{d} ( i )}{( {\sum }_{n = 1}^{m} {T}_{np} ( i ) )} , \qquad [ 1 ]$$

wherein:

T_{d}(i) is the torque output by the driving engine at the rotation speed i,

Tₚₖₒₖ(i) is the total torque of all the hydraulic pumps powered by the driving engine,

n is an index representing the running number of the hydraulic pump,

m is the total number of hydraulic pumps powered by the driving engine (e.g. m=2 in the machine of FIG. 1).

Thus, by means of the deficiency divisor h, e.g. the operation of the driving engine M and the hydraulic pumps PUMP1 and PUMP2 of the machine of FIG. 1 can be assessed, by applying the equation [1], in the following way:
if h>1, the torque Tₚₖₒₖ(i) required by the hydraulic pumps PUMP1 and PUMP2 is lower than the torque T_{d}(i) output by the driving engine M at this rotation speed i.
if h=1, the torque Tₚₖₒₖ(i) required by the hydraulic pumps PUMP1 and PUMP2 is equal to the torque T_{d}(i) output by the driving engine M at this rotation speed i.
if h<1, the torque Tₚₖₒₖ(i) required by the hydraulic pumps PUMP1 and PUMP2 is higher than the torque T_{d}(i) output by the driving engine M at this rotation speed i, whereby the driving engine M will stall.

In all cases where the total torque Tₚₜₒₜ of the torques T₁ₚ and T₂ₚ required by the hydraulic pumps PUMP1 and PUMP2 does not exceed the torque T_{d} of the driving engine M, that is, when the deficiency divisor h>1, the requested volume flows Q_{1P} ja Q₂ₚ of the hydraulic pumps PUMP1 and PUMP2 will be output as set by the driver of the machine applying controls in the cabin of the machine. However, when h>1, the rotation speed i of the driving engine M and the requested displacements V₁ₚ and V₂ₚ of the hydraulic pumps PUMP1 and PUMP2 will be adjusted so that said requested volume flows Q_{1P} and Q₂ₚ can be output with optimal fuel economy, that is, in a way that the torque T_{d} output by the driving engine M is as close to the sum Tₚₜₒₜ of the torques T₁ₚ and T₂ₚ required by the hydraulic pumps PUMP1 and PUMP2 (and thereby the deficiency divisor h≈1, typically 0.9 . . . 1.2 and advantageously 1.0 . . . 1.1). It should be noted that both the rotation speed i of the driving engine M and the (requested) displacements V₁ₚ ja V₂ₚ of the hydraulic pumps PUMP1 and/or PUMP2 have to be adjusted, because the real volume flows Q₁ₜ and Q₂ₜ are dependent on both of these. Therefore, the adjustment is made by searching for such a combination of the rotation speed i of the driving engine M and the displacements V₁ₚ and V₂ₚ of the hydraulic pumps PUMP1 and PUMP2 that the volume flows Q₁ₜ and Q₂ₜ are realized but the driving engine M runs at a rotation speed at which its energy consumption is the lowest possible. In this way, the driving engine M can always be run in such a way that its energy consumption (consumption of diesel fuel) is as low as possible but it still never stalls because of the sum Tₚₖₒₖ of the torques T₁ₚ and T₂ₚ required by the pumps PUMP1 and PUMP2 exceeding the torque T_{d} output by the driving engine M.

A torque value T_{d}(i) corresponding to a given rotation speed i of the driving engine is obtained by entering the corresponding torque values, measured or provided by the engine manufacturer and corresponding to different rotation speeds i, in the memory of the control unit of the machine (e.g. in table format), or by forming a function whose graph corresponds to the torque graph, measured or provided by the engine manufacturer, as well as possible in the coordinate system of rotation speed and torque. A suitable function for calculating the torque T_{d}(i) corresponding to a given rotation speed i of the driving engine M is, for example, the graph of the secondary equation that follows the torque graph obtained by measuring or provided by the engine manufacture as well as possible

Td(i)=Ai²+Bi+C, [2]

wherein A, B, and C are constants.

This kind of an adaptation is presented for the machine of FIG. 1 in FIG. 3.

It is also possible to adapt the graph by applying different values for the constants A, B and C at different ranges of the rotation speed, whereby the adaptation can further be made to follow more closely the torque graph provided by the engine manufacturer. It is also possible to apply other functions, for example polynomial functions of different degrees, for driving engines of different types, depending on the way of operation of the driving engine. In combustion engines, however, the torque often follows quite closely the shape of the graph of the secondary polynomial function; therefore, the secondary polynomial function in many cases represents well the relationship of the torque and the rotation speed of the driving engine.

Because the driving engine M has to power not only the hydraulic pumps PUMP1 and PUMP2 but also the auxiliary devices of the machine, such as the coolant pump, the battery charger and the blower unit of the air conditioner, the effective torque of the driving engine is used as the torque for the driving engine M in the control:

T_{deff}(i)=k_{d}*T_{d}(i), [3]

wherein

k_{d} is a so-called auxiliary device coefficient (for the machine of FIG. 1, the value k_{d}=0.6 . . . 0.8 is used, depending on the rotation speed).

In the present case, the value k_{d}=0.80 is used, whereby 20% of the available torque of the driving engine M is always at the disposal of devices other than the hydraulic pumps PUMP1 and PUMP2. Normally, the value of the auxiliary device coefficient may vary from K_{d}=0.5 to K_{d}=0.95, depending on e.g. the rotation speed. In some cases, a value variable as the function of the rotation speed may also be used as the auxiliary device coefficient. Thus, the auxiliary device coefficient may be determined as a value of a suitable function depending on the rotation speed. Thus, in practical applications, the equation [1] may also be written in a format in which the effect of the auxiliary devices of the driving engine on the produced torque is taken into account:

$$h ( i ) = \frac{{T}_{deff} ( i )}{( {\sum }_{n = 1}^{m} {T}_{np} ( i ) )} \qquad [ 4 ]$$

In the working machine of FIG. 1, the displacements V₁ₚ and V₂ₚ of the hydraulic pumps PUMP1 and PUMP2 are controlled electronically by control currents I₁ₒₚ and I₂ₒₚ. The control currents I₁ₒₚ and I₂ₒₚ are restricted within the scope of the torque T_{d} produced by the driving engine M. The control current values of the hydraulic pumps PUMP1 and PUMP2 are determined according to the following variable parameters: the working pressures p₁ and p₂ of the hydraulic pumps PUMP1 and PUMP2, the pump specific volume flows Q₁ₚ and Q₂ₚ requested by the driver of the machine, and the rotation speed i of the driving engine M. The terms o₁ₚₒ and o₂ₚₒ refer to the percent [0 to 100%] shares of the maximum volume flows Q₁ₚₘₐₓ and Q₂ₚₘₐₓ of the hydraulic pumps PUMP1 and PUMP2. In this case, the hydraulic pumps PUMP1 and PUMP2 are equal, each producing an equal maximum volume flow Qₘₐₓ. Moreover, the following constant parameters are applied in the equations for calculation: The maximum displacement V_{gmax} of the hydraulic pumps PUMP1 and PUMP2, the efficiencies ηᵥ, ηₕₘ and ηₖₒₖ of the hydraulic pumps PUMP1 and PUMP2=ηᵥ*ηₕₘ, the maximum rotation speed iₘₐₓ of the driving engine M, the maximum volume flow Qₘₐₓ output by one hydraulic pump=V_{gmax}*iₘₐₓ*ηᵥ, and the auxiliary device coefficient k_{d}=0.6 . . . 0.8.

The working pressures p₁ and p₂ of the hydraulic pumps PUMP1 and PUMP2 are measured by pressure transmitters B1 and B2. In practice, the control unit is supplied with the ranges I₁ₘᵢₙ . . . I₁ₘₐₓ and I₂ₘᵢₙ . . . I₂ₘₐₓ of the current values I₁ and I₂ as input parameters produced by the pressure transmitters B1 and B2 (for the pressure transmitters of the machine of FIG. 1, I₁(p)=I₂(p)=4 . . . 20 mA, that is, I₁ₘᵢₙ=I₂ₘᵢₙ=4 mA, which corresponds to the measured pressure of 0 bar, and I₁ₘₐₓ=I₂ₘₐₓ=20 mA, which corresponds to the measured pressure of 400 bar). Moreover, the control unit is supplied with the hydraulic pump specific requests for volume flows Q_{IP} and Q₂ₚ entered by the driver applying the controls, as well as the rotation speed i of the driving engine M.

The relationship between the current values of the pressure transmitters B1 and B2 obtained from the system, and the working pressures p₁ and p₂ is obtained by the equation:

$${p}_{n} ( i ) = \frac{{p}_{nmax}}{( {I}_{nmax} - {I}_{nmin} )} \cdot ( {I}_{n} ( p ) - {I}_{nmin} ) , \qquad [ 5 ]$$

wherein

pₙ(i) is the measured pressure of a hydraulic pump PUMPn, that is, p₁ or p₂ in the machine of FIG. 1 (between 0 and 400 bar);

Iₙ(p) is the current value corresponding to the measured pressure (that is, between 4 and 20 mA);

Iₙₘᵢₙ is the lowest current value of a pressure transmitter Bn;

Iₙₘₐₓ is the highest current value of the pressure transmitter Bn;

pₙₘₐₓ is the highest pressure that can be measured by the pressure transmitter of the pump PUMPₙ (that is, the maximum pressure of said pressure transmitter).

Further, in the equation [5], the lower index n thus indicates the hydraulic pump which the measurement of the pressure transmitter Bn relates to.

Thus, for the machine of FIG. 1, n=1 for the hydraulic pump PUMP1 and n=2 for the hydraulic pump PUMP2. Also, in the equations hereinbelow in this application, the same index n is used to indicate the running number of the hydraulic pump. The working pressure can also be measured by different pressure measuring means. The measurement data obtained from these may be a voltage value, digital measurement data, or another type of measurement data instead of a current value.

The torque graph for the driving engine M is obtained, in the case of the machine according to FIG. 1, from a table formed according to the torque graph provided by the manufacturer, where the torque values corresponding to the different rotation speeds are given (or alternatively, from an adjustment of the interdependence of the rotation speed and the torque made, for example by the equation [2], according to the torque graph provided by the manufacturer). This gives the torque T_{deff} available for the hydraulic pumps by applying the auxiliary device coefficient k_{d}: T_{deff}(i)=k_{d}*T_{d}(i). It is also possible to define a graph for the effective torque of the driving engine, where the values of the torque T_{d}(i) corresponding to the different rotation speeds i are multiplied by the auxiliary device coefficient k_{d}, whereby the values for the deficiency divisor h are obtained directly by the equation [4], without multiplying the torque values with the auxiliary device coefficient k_{d}.

For the hydraulic pumps PUMP1 and PUMP2, the volume flows Q₁ₚ and Q₂ₚ requested by the driver, guideline values o₁ₚₒ and o₂ₚₒ (proportioned to the rotation speed i of the driving engine M), as well as the displacements (V₁ₚ and V₂ₚ) and the respective torques (T₁ₚ and T₂ₚ) are calculated as follows:

$${Q}_{np} = \frac{{o}_{n}}{100} \cdot {Q}_{nmax} \qquad [ 6 ]$$

wherein

Qₙₚ is the volume flow requested of the hydraulic pump PUMPn;

Qₙₘₐₓ is the maximum volume flow of the hydraulic pump PUMPn;

oₙ is a relative share of the maximum volume flow of the hydraulic pump PUMPn (in percent).

In some cases, adjusted volume flow values Qₙₚ (that is, the volume flow values Q₁ₚ and Q₂ₚ requested by the driver in the case of the machine of FIG. 1) are obtained by the control unit directly from the controls. In this case, the calculation by the equation [6] does not need to be performed.

Guideline control values o₁ₚₒ and o₂ₚₒ for the hydraulic pumps PUMP1 and PUMP2 are obtained by the equation:

$${o}_{npo} = \frac{100 \cdot {Q}_{np}}{i \cdot {V}_{ngmax} \cdot {η}_{v}} , \qquad [ 7 ]$$

wherein

oₙₚₒ is a guideline control value for the hydraulic pump PUMPn (that is, the guideline position in percentage of the position of the control from the maximum value of the adjustment range of the control), for achieving the volume flow Qₙₚ controlled by the driver of the machine,

V_{ngmax} is the maximum displacement of the hydraulic pump PUMPn; and

ηₙᵥ is the volumetric efficiency of the hydraulic pump PUMPn.

A set value for the displacements V₁ₚ and V₂ₚ of the hydraulic pumps PUMP1 and PUMP2 is obtained on the basis of the guideline rotation speed.

$${V}_{np} = \frac{{o}_{np}}{100} \cdot {V}_{ngmax} , \qquad [ 8 ]$$

wherein

Vₙₚ is thus the set value for the displacement of the hydraulic pump PUMPn, for achieving the volume flow Qₙₚ.

On the basis of this, it is possible to determine the torque T₁ₚ and T₂ₚ required by the hydraulic pumps PUMP1 and PUMP2.

$${T}_{np} = \frac{{V}_{np} \cdot {p}_{n}}{2 \cdot π \cdot {η}_{nmh}} , \qquad [ 9 ]$$

wherein

ηₙₘₕ is the mechanical hydraulic efficiency of the hydraulic pump PUMPn,

Tₙₚ is the torque required by the hydraulic pump PUMPn;

pₙ is the working pressure of the hydraulic pump PUMPn.

In this way, a value for the deficiency divisor h(i) can be derived from the torques T₁ₚ and T₂ₚ required for the hydraulic pumps PUMP1 and PUMP2, defined for the machine of FIG. 1, when the torque T_{deff}(i) output by the driving motor M (and available to the hydraulic pumps) is also determined as a function of the rotation speed of the driving motor M in the above presented ways of defining the torques.

If the deficiency divisor h>1, the rotation speed i of the driving engine M is adjusted in the above mentioned way, that is, in such a way that the value of the deficiency divisor will approach the value h≈1. In general, such optimization of the running of the driving engine entails, applying the equation [4], that the rotation speed i is solved from the equation:

$$h ( i ) = \frac{{T}_{deff ( i )}}{( {\sum }_{n = 1}^{m} {T}_{np} ( i ) )} = 1 , \qquad [ 10 ]$$

wherein

m is the number of pumps (that is, m=2 for the machine of FIG. 1), and

T_{deff}(i)=k_{d}·T_{d}(i) that is, the effective torque of the driving engine.

When the deficiency divisor h>1, the rotation speed i of the driving engine corresponding to the value h≈1 can be found by solving a function of optimization corresponding to the value h=1 by deriving the following equation from the equation [10]:

$$i \cdot {k}_{d} ( i ) \cdot {T}_{d} ( i ) - \frac{1}{2 {πη}_{kok}} \cdot ( {\sum }_{1}^{m} {Q}_{np} \cdot {p}_{n} ) = 0 \qquad [ 11 ]$$

wherein

ηₙₖₒₖ is (n the total efficiency of the hydraulic pumps (ηₙₖₒₖ=ηₙₕₘ×ηₙᵥ). In the case of a combined pile driving rig shown in FIG. 1, the hydraulic pumps PUMP1 and PUMP2 are identical, so that for them, ηₙₕₘ=ηₕₘ and ηₙᵥ=ηᵥ. In a different case, the total efficiency ηₖₒₖ is calculated for each hydraulic pump separately.

From this equation, the zero position (i_{opt#}) is solved in the range from iₘᵢₙ to iₘₐₓ by the split half method. For the driving engine M of the machine 10 of FIG. 1, iₘᵢₙ=800 r/min and iₘₐₓ=2100 r/min. Tests carried out have shown that in the case of the driving engine M of the machine of FIG. 1, a sufficiently accurate value is obtained by performing 8 iterations.

However, this solution does not take into account that the hydraulic pumps have a maximum displacement V_{ngmax} which, for example for the hydraulic pumps PUMP1 and PUMP2 in the machine 10 of FIG. 1, is V_{1gmax}=V_{2gmax}=260 cm³ and has to be taken into account separately. Consequently, the minimum rotation speed has to be solved, at which the requested volume flow Qₙₚ for each hydraulic pump is achieved,

$${i}_{min\_n} = \frac{1000 \cdot {Q}_{np}}{{V}_{ngmax} \cdot {η}_{nvol}} \qquad [ 12 ]$$

wherein

n indicates the hydraulic pump in question (that is, n=1 or n=2 for the machine of FIG. 1);

ηₙᵥₒₗ is the volumetric efficiency of the hydraulic pump PUMPn. For the hydraulic pumps PUMP1 and PUMP2, ηₙᵥₒₗ=ηᵥₒₗ=0.95.

iₘᵢₙ_{_}ₙ is the lowest rotation speed of the driving engine, at which the volume flow Qₙₚ is supplied by the PUMPn (that is, for example PUMP1 or PUMP2).

The selected optimum rotation speed iₒₚₜ is the highest rotation speed determined according to the volume flows Qₙₚ requested by the single hydraulic pumps PUMPn, or the optimum rotation speed determined by the equation (11), if it is applicable, that is, if the maximum displacement V_{ngmax} of any of the hydraulic pumps is not exceeded. Consequently, the optimum rotation speed is selected by comparison:

iₒₚₜ=MAX(iₘᵢₙ_{_}₁,iₘᵢₙ_{_}₂ . . . iₘᵢₙ_{_}ₘ,i_{opt#}) [13]

where m indicates the number of hydraulic pumps; that is, m=2 in the embodiment of FIG. 1.

Next, the realized displacements (V₁ₜ and V₂ₜ) are selected for the hydraulic pumps PUMP1 and PUMP2. In general, this is done by comparing three values for each hydraulic pump driven by the driving engine M: the requested displacement multiplied by the deficiency divisor h (h*Vₙₚ), the requested displacement (Vₙₚ), and the maximum displacement of the hydraulic pump (V_{ngmax}), and by selecting the lowest value:

Vₙₜ=min(h·Vₙₚ,Vₙₚ,V_{ngmax}) [14]

In other words, if the deficiency divisor h<1, then the displacement multiplied (scaled down) by the deficiency divisor h determined on the basis of the volume flow Qₙₚ requested by the driver applying the control) is selected. If the deficiency divisor h>1, then the requested displacement Vₙₚ is selected. If both of the above displacements exceed the maximum displacement V_{ngmax} of the hydraulic pump (the equations for calculation make this possible before this step), then the maximum displacement V_{ngmax} is selected. Thus, in a case where h<1, the displacement Vₙₚ of each hydraulic pump is reduced to the value Vₙₜ<Vₙₚ accordingly.

Consequently, in loading situations in which one of the hydraulic pumps produces a low pressure but has a maximum displacement, and another hydraulic pump produces a high pressure but has a small displacement correspondingly, and the deficiency divisor h is slightly below 1 (typically from 0.9 to 1), then the displacement of the hydraulic pump producing the higher working pressure is restricted first when this control method is applied. This will be continued until the displacement Vₙₚ multiplied by the deficiency divisor h becomes lower than the maximum displacement V_{ngmax}.

In the machine of FIG. 1, the realized displacements V₁ₜ and V₂ₜ can be converted to control currents I₁ₒₚ and I₂ₒₚ [mA] of the hydraulic pumps PUMP1 and PUMP2 by applying the following equation:

$${I}_{nop} = {I}_{nopmin} + \frac{{V}_{nt} \cdot {I}_{nopmax}}{{V}_{ngmax}} , \qquad [ 15 ]$$

wherein

Iₙₒₚ is the control current for the hydraulic pump PUMPn, corresponding to the displacement Vₙₜ

Iₙₒₚₘᵢₙ is the minimum control current for the hydraulic pump PUMPn,

Iₙₒₚₘₐₓ is the maximum control current for the hydraulic pump PUMPn (thereby corresponding to the displacement V_{ngmax}).

When a combined pile driving rig of FIG. 1, equipped with an engine control system of FIG. 2, is applied for e.g. driving bored piles into the ground, the driver of the machine 10 applies a joystick first to adjust the control values o₁ₚ and o₂ₚ to values corresponding to the (requested) volume flows Q₁ₚ and Q₂ₚ desired to be supplied to the hydraulic actuators needed for this work. Thus, the rotation speed i of the driving engine M tends to be automatically adjusted so that the volume flows Q₁ₚ and Q₂ₚ produced by the hydraulic pumps PUMP1 and PUMP2 correspond to these control values. Next, the control unit of the machine 10 will determine the pressures p₁ and p₂ of the pressurized medium produced by the hydraulic pumps PUMP1 and PUMP2 at the rotation speed i of the driving engine M corresponding to these volume flows Q1p and Q2p, by measuring these with the pressure transmitters B1 and B2. By means of the obtained pressures p₁ and p₂, the rotation speed i and the controlled momentary displacements Vₚ₁ and Vₚ₂ of the hydraulic pumps PUMP1 and PUMP2, the torques Tₚ₁ and Tₚ₂ required by the hydraulic pumps PUMP1 and PUMP2 are determined by the equations [7], [8] and [9], followed by the torque T_{deff} corresponding to the rotation speed of the driving engine M by the equation [3], and further the deficiency divisor h. If the total torque Tₚₜₒₜ required by the hydraulic pumps PUMP1 and PUMP2 powered by the driving engine M exceeds the torque T_{deff} produced by the driving engine (that is, h<1), then the displacement V₁ₚ and V₂ₚ of the hydraulic pumps PUMP1 and PUMP2, controlled according to the request by the driver, is turned down and the rotation speed i of the driving engine M is turned up so that the torques T₁ₚ and T₂ₚ required by the hydraulic pumps PUMP1 and PUMP2 are reduced to a value that is not higher than the effective torque T_{deff} output by the driving engine M at the controlled running speed i. The aim is to maintain the realized volume flow Q₁ₜ and Q₂ₜ output by the hydraulic pumps as close to the requested volume flow values Qₚ₁ and Qₚ₂ as possible (i.e. such that the sum of the torques T₁ₚ and T₂ₚ required by the hydraulic pumps PUMP1 and PUMP2 does not exceed the effective torque T_{deff} output by the driving engine). If, on the other hand, the total torque Tₚₖₒₖ of the hydraulic pumps powered by the driving engine remains initially lower than the effective torque T_{deff} of the driving engine, the running speed i of the driving engine M is turned down and the displacement of the hydraulic pumps PUMP1 and PUMP2 is turned up by applying the optimization function according to the equation [10] and the derived equation [11], taking into account that the displacement of the hydraulic pumps is finite and that the equation [11] may produce a value for the rotation speed i_{opt#} that does not satisfy the volume flows Q₁ₚ and Q₂ₚ requested of the hydraulic pumps PUMP1 and PUMP2 because this would require that one or both of the hydraulic pumps PUMP1 and PUMP2 had a larger displacement than can be produced by them (that is, a situation in which V₁ₚ and/or V₂ₚ>V_{ngmax}). Therefore, the lowest possible rotation speed iₘᵢₙ_{_}₁ and iₘᵢₙ_{_}₂ required is calculated for each hydraulic pump PUMP1 and PUMP2 by the equation (12), and the highest one is selected from these and the rotation speed value I_{opt#} calculated by the equation [10], to make sure that the desired volume flows Q₁ₚ and Q₂ₚ are really produced at an optimum rotation speed iₒₚₜ of the driving engine M. In the case of the machine 10 of FIG. 1, all these calculations can be performed by the control unit that controls the hydraulic system (and thereby the hydraulic pumps PUMP1 and PUMP2) of the machine 10.

FIGS. 4 to 7 show, as an example, graphs of one loading situation of the machine 10 of FIG. 1 (controls: o₁ₚₒ, =35%, o₂ₚₒ=50%, p₂=290 bar, and i=1200 1/min) as a function of the working pressure of the hydraulic pump PUMP1 [0 to 400 bar]. FIGS. 4 to 7 show what happens when both of the hydraulic pumps PUMP1 and PUMP2 are capable of producing the requested volume flow. In all of the situations shown in FIGS. 4 to 7, the hydraulic pump PUMP2 has a constant pressure of 290 bar.

FIG. 4 shows the value of the deficiency divisor h as a function of the working pressure p₁ of the hydraulic pump PUMP1. The figure shows that the driving engine M running at this rotation speed i is capable of providing the volume flows Q₁ₚ and Q₂ₚ of the hydraulic pumps PUMP1 and PUMP2 requested by the driver, as long as the working pressure of the hydraulic pump PUMP1 p₁≤285 bar. In other words, at pressures of the hydraulic pump PUMP1 lower than this value, the rotation speed i of the driving engine and the displacements V₁ₚ and V₂ₚ would be adjusted (by applying the way of optimization presented in equation [10]) so that the deficiency divisor h would remain close to the value h 1. Without such adjustment, the optimum situation is at the working pressure of the hydraulic pump PUMP1, p₁=285 bar.

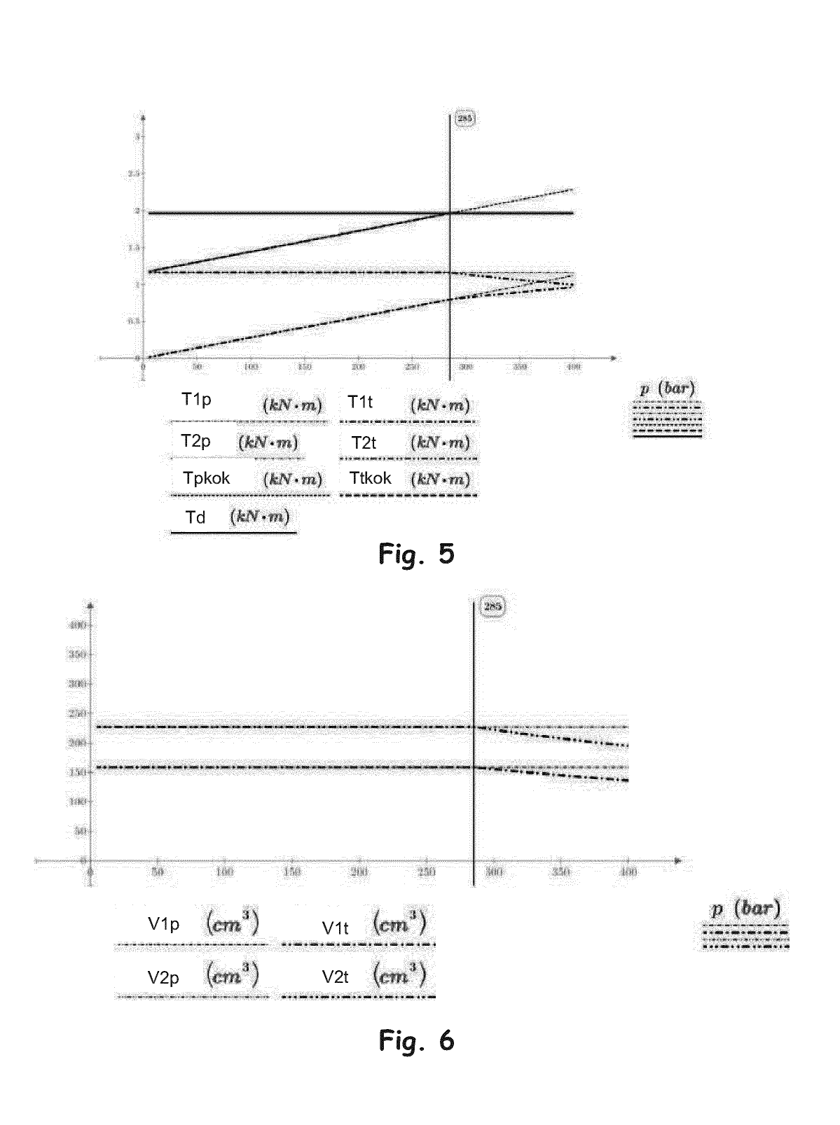

FIG. 5 shows the torque of the driving engine M (solid bolded line) and the torques T₁ₚ and T₂ₚ required by the hydraulic pumps PUMP1 and PUMP2 (single and double lines of dots and dashes) at a selected rotation speed i of the driving engine M, as well as the torques Tᵢₚ and T₂ₚ that can be realized at this rotation speed (bolded line of dots and dashes and double line of dots and dashes) as a function of the working pressure p₁ of the hydraulic pump PUMP1. Furthermore, FIG. 5 shows the sum Tₚₜₒₜ of the torques Tᵢₚ and T₂ₚ required by the hydraulic pumps PUMP1 and PUMP2 (line of dense dashes) as well as the sum Tₚₜₜₒₜ of the torques T₁ₜ ja T₂ₜ that can be realized (bolded line of sparse dashes) as a function of the working pressure p₁ of the hydraulic pump PUMP1.

FIG. 6 shows the displacements Vₚ₁ (line of dots and dashes) and Vₚ₂ (double line of dots and dashes) required of the hydraulic system, as well as the displacements Vₜ₁ (bolded line of dots and dashes) and Vₜ₂ (bolded double line of dots and dashes) that can be realized at this rotation speed i of the driving engine M, as a function of the working pressure p₁ of the pump PUMP1.

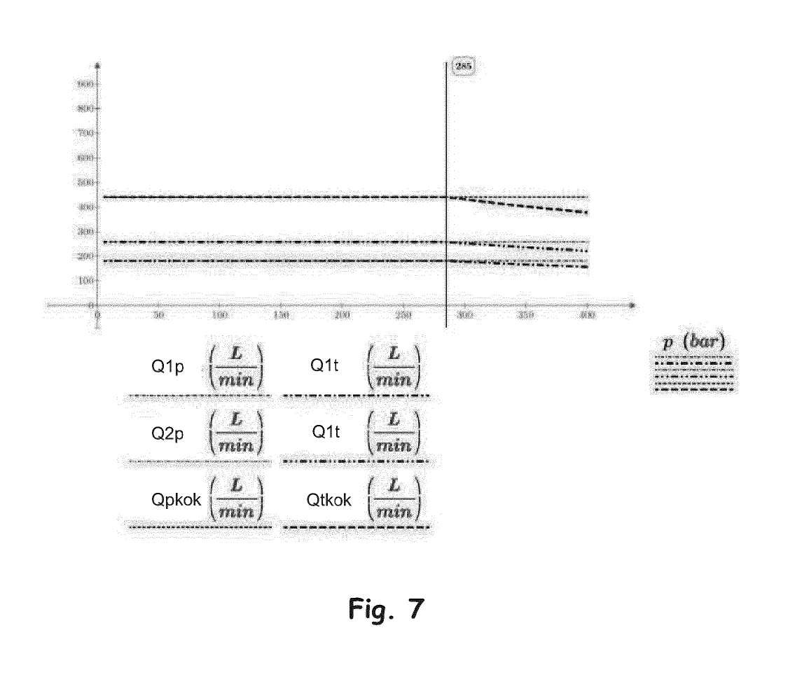

FIG. 7 shows the volume flows Q₁ₚ (line of dots and dashes) and Q₂ₚ (double line of dots and dashes) requested of the hydraulic pumps PUMP1 and PUMP2, and the realized volume flows Q₁ₜ (bolded line of dots and dashes) and Q₂ₜ (bolded double line of dots and dashes) at the selected rotation speed i of the driving engine M, as a function of the working pressure p₁ of the hydraulic pump PUMP1. Furthermore, FIG. 7 shows the requested total volume flow Qₚₖₒₖ (line of dense dashes) of both of the hydraulic pumps PUMP1 and PUMP2, and the realized total volume flow Qₜₖₒₖ (bolded line of sparse dashes) output by both of the hydraulic pumps PUMP1 and PUMP2 at the rotation speed i of the driving engine, as a function of the working pressure p₁ of the hydraulic pump PUMP1

The control of the pumps PUMP1 and PUMP2 of the machine 10 of FIG. 1 is composed of three steps, the first step being formed by the above described control of the rotation speed i of the driving engine M and the displacements of the hydraulic pumps PUMP1 and PUMP2.

The second step prevents the hydraulic pumps PUMP1 and PUMP2 from providing the actuators with too much output. This step has second priority in the control. The hydraulic pumps PUMP1 and PUMP2 are controlled according to the loading (electronic control). This is implemented in a way known as such, that is, by comparing the pressure difference between the working pressures p₁, p₂ and the load pressures of the hydraulic pumps. Thus, the control routine can be, for example, of the following type:

Pressure difference>20 bar→the displacement Vₚ₁ of the hydraulic pump PUMP1 and/or the displacement Vₚ₂ of the hydraulic pump PUMP2 is turned down

Pressure difference=15 to 20 bar→the displacements V₁ₚ and V₂ₚ of the hydraulic pumps PUMP1 and PUMP2 are not changed

Pressure difference>15 bar→the displacement V₁ₚ of the hydraulic pump PUMP1 and/or the displacement V₂ₚ of the hydraulic pump PUMP2 is turned up.

The third step adjusts the displacement V₁ₚ and V₂ₚ of the hydraulic pumps PUMP1 and PUMP2 according to the sum of the openings of the control valve stems. A program in the control unit adds up the volume flows Q₁ₚ and Q₂ₚ (e.g. valve current values) requested by the driver applying the controls, and adjusts the displacements V₁ₚ and V₂ₚ of the hydraulic pumps PUMP1 and PUMP2 to correspond to these volume flow values Q₁ₚ and Q₂ₚ. Instructions for controlling the currents of the control valve stems are taken from the same valve block. The control unit adjusts the rotation speed i of the driving engine M according to predetermined rotation speeds, depending on the movement performed by the driver of the machine 10.

The method and the system according to the invention for controlling the driving engine and the hydraulic pumps of a machine can be implemented, in many respects, in a way different from the example embodiment presented above. As can be understood from the above presented theory, the method can also be applied for the control of systems which, deviating from the machine 10 of FIG. 1, have only one hydraulic pump or more than two hydraulic pumps powered by the driving engine of the machine. Moreover, the driving engine does not need to be a diesel engine but it may also be another engine that generates a rotary motion, such as e.g. a petrol/gasoline engine, an electric motor, a steam engine, a steam turbine, or a gas turbine. The torque corresponding to a given rotation speed of the driving engine can, in the method according to the invention, also be determined by any other method than on the basis of the interdependence between the torque and the rotation speed given by the manufacturer, for example by measuring the torque from the drive shaft of the driving engine, or on the basis of one or more items of information obtained from the control system of the driving engine. The hydraulic pumps used can be various hydraulic variable displacement pumps, and in the case of more than one hydraulic pump, not all the hydraulic pumps need to be, in principle, variable displacement pumps, because the value of the deficiency divisor h can thus be brought to the target value h≈1 by adjusting the variable displacement hydraulic pumps. Also, the torque required by the hydraulic pumps may be determined by a way different from the principle presented in the equations [6] to [9]. The torque could be determined, for example, by measuring it from the drive shaft of each hydraulic pump, on the basis of the forces effective on the frame of the hydraulic pump or the mounting structures relating to it, or on the basis of data obtained from the control system of the driving engine.

In principle, the method according to this invention can be applied in any machines with a driving engine for powering hydraulic pumps that supply pressurized medium to the apparatuses of the machine. Further, the application of the method is not limited to the pressurized medium used in the hydraulic system. In principle, the same method could also be applied in systems applying a gaseous pressurized medium (compressed air). Thus, the method according to the invention is not limited to the above presented example embodiments but it can be implemented in various ways within the scope of the appended claims.

1. A method for controlling the driving engine (M) and hydraulic pumps (PUMP1, PUMP2) of a hydraulic machine, the method comprising—driving at least one hydraulic variable displacement pump (PUMP1, PUMP2) that supplies pressurized medium to the hydraulic system of the machine by the driving engine (M),
determining the working pressure (pi, p₂) and volume flow (Qiₚ, Q₂ₚ) output from at least one hydraulic pump (PUMP1, PUMP2),
determining the torque (Tiₚ, T₂ₚ) required of at least one hydraulic pump (PUMP1, PUMP2) or the total torque (Tₚₖ₀ₖ) required by two or more hydraulic pumps (PUMP1, PUMP2) by means of the working pressure (p₁, p₂) and volume flow (Q₁ₚ, Q₂ₚ) of pressurized medium output from at least one hydraulic pump (PUMP1, PUMP2), as well as the rotation speed (i) of the driving engine (M);
controlling the rotation speed (i) of the driving engine (M) and the displacement (Viₚ, V₂ₚ) of at least one hydraulic pump (PUMP1, PUMP2) automatically so that the torque (T_{d}, T_{deff}) produced by the driving engine (M) approaches the torque (Tiₚ, T₂ₚ) required by at least one hydraulic pump (PUMP1, PUMP2) driven by the driving engine (M), or the total torque (Tₚₖₒₖ) of two or more hydraulic pumps (PUMP1, PUMP2) in such a way that the volume flow (Q₁ₚ, Q₂ₚ) produced by at least one hydraulic pump (PUMP1, PUMP2) will remain unchanged.

2. The method according to claim 1, wherein the applied torque produced by the driving engine (M) is the effective torque (T_{deff}) obtained by multiplying the torque (T_{d}) of the driving engine, measured or based on data provided by the manufacturer, with an auxiliary device coefficient (k_{d}) that takes into account the torque needed for driving the auxiliary devices of the machine, in the control of the driving engine (M).

3. The method according to claim 1, wherein the volume flow of the pressurized medium is given a requested value (Q₁ₚ, Q₂ₚ) that is changed if the implementation of the preset value for maintaining the required working pressure (p₁, p₂) requires a higher torque (Tₚi, Tₚ₂, Tₚₖ₀ₖ) than the torque (T_{d}, T_{deff}) produced by the driving engine (M) at this rotation speed (i).

4. The method according to claim 3, which method further comprises comparing the torque (T₁ₚ, T₂ₚ) required by at least one hydraulic pump (PUMP1, PUMP2) or the total torque (Tₚₜₒₜ) of two or more hydraulic pumps (PUMP1, PUMP2) with the torque (Td, T_{deff}) produced by the driving engine (M) when the volume flow is the volume flow (Q₁ₚ, Q₂ₚ) requested of the hydraulic pumps (PUMP1, PUMP2); and if the torque (Tiₚ, T₂ₚ) required by at least one hydraulic pump (PUMP1, PUMP2) or the total torque (Tₚₖ₀ₖ) of two or more hydraulic pumps (PUMP1, PUMP2) at this rotation speed of the driving engine (M) is higher than the torque (T_{d}, T_{deff}) produced by the driving engine (M), the displacement (V₁ₚ, V₂ₚ) of at least one hydraulic pump (PUMP1, PUMP2), reducing the displacement (V_{P}, V₂ₚ) of at least one hydraulic pump (PUMP1, PUMP2), to reduce the volume flow (Qₚ, Q₂ₚ) and thereby the torque (Tiₚ, T₂ₚ) required by at least one hydraulic pump (PUMP1, PUMP2) to a new value (T₁ₜ, T₂ₜ), or to reduce the total torque (Tₚₖₒₖ) of two or more hydraulic pumps (PUMP1, PUMP2) to a new value (Tₚₖₒₖ) so that the torque (T_{d}, T_{deff}) produced by the driving engine (M) is at least equal to the torque (T₁ₜ, T₂ₜ) required by at least one hydraulic pump (PUMP1, PUMP2) at this changed displacement (V₁ₜ, V₂ₜ), or the total torque (Tₜₖₒₖ) required by two or more hydraulic pumps (PUMP1, PUMP2) at these changed displacements (V₁ₜ, V₂ₜ).

5. The method according to claim 1, wherein the applied torque of the driving engine (M) is the torque (T_{d}(i), T_{deff}(i)) defined on the basis of the relation between the rotation speed and the torque predetermined for the driving engine (M) on the basis of the rotation speed (i) of the driving engine (M).

6. The method according to claim 5, wherein a mathematical model is formed for the interdependence between the rotation speed and the torque of the driving engine (M), for forming a graph in the coordinate system of the rotation speed and the torque, that corresponds to the torque values (T_{d}(i)), obtained by measurement or provided by the manufacturer of the driving engine (M), as a function of the rotation speed (i) of the driving engine (M).

7. The method according to claim 6, wherein the mathematical model is a polynomial function.

8. The method according to claim 1, wherein a deficiency divisor h is defined, which is the ratio between the torque (T_{d}, T_{deff}) produced by the driving engine (M) and the torque (T₁ₚ, T₂ₚ) required by at least one hydraulic pump (PUMP1, PUMP2), or the sum (Tₚₖ₀ₖ) of the torques required by two or more hydraulic pumps (PUMP1, PUMP2).

9. The method according to claim 8, wherein the rotation speed (i) of the driving engine (M) and the displacement (V₁ₚ, V₂ₚ) of at least one hydraulic pump (PUMP1, PUMP2) are controlled according to the deficiency divisor h so that if the value of the deficiency divisor h>1, the rotation speed (i) of the driving engine (M) and the displacement (V₁ₚ, V₂ₚ) of at least one hydraulic pump (PUMP1, PUMP2) are adjusted so that the value of the deficiency divisor h is reduced, but the volume flow (Q₁ₚ, Q₂ₚ) produced by at least one hydraulic pump (PUMP1, PUMP2) remains unchanged.

10. The method according to claim 8, wherein the rotation speed of the driving engine (M) and the displacement (V₁ₚ, V₂ₚ) of at least one hydraulic pump (PUMP1, PUMP2) are maintained unchanged when the deficiency divisor h=0.9 . . . 10.2.

11. A system for controlling the driving engine (M) and hydraulic pumps (PUMP1, PUMP2) of a hydraulic machine, the system comprising a control unit for controlling the hydraulic system of the machine, and wherein the control unit is configured to control the driving engine (M) and at least one hydraulic pump (PUMP1, PUMP2) of the machine according to a method according to claim 1.

12. The system according to claim 11, wherein the driving engine (M) powering the hydraulic pumps (PUMP1, PUMP2) is a diesel engine.

13. The system according to claim 11, comprising at least two hydraulic variable displacement pumps (PUMP1, PUMP2) powered by the driving engine (M).

14. A pile driving rig comprising a system according to claim 11.

15. A pile driving rig which pile driving rig is a combined pile driving rig for performing at least one of the following: driving bored piles into the ground by screwing, driving rammed piles into the ground by impact driving, or sinking grooved/steel piles into the ground by vibration or pressing.
